(19) United States
(12) Patent Application Publication
(10) Pub. No.: US 2014/0169841 A1
(43) Pub. Date: Jun. 19, 2014

(54) IMAGE FORMING APPARATUS

(71) Applicant: KONICA MINOLTA, INC., Chiyoda-ku (JP)

(72) Inventors: Hiroshi MIZUNO, Aisai-shi (JP); Osamu Akiyama, Tama-shi (JP); Yasuaki Tomoda, Toyohashi-shi (JP); Naoki Nonoyama, Toyokawa-shi (JP); Kiyomitsu Koyama, Toyokawa-shi (JP); Masaki Hata, Nagoya-shi (JP); Shiro Umeda, Toyokawa-shi (JP); Koji Soda, Toyokawa-shi (JP)

(73) Assignee: KONICA MINOLTA, INC., Chiyoda-ku (JP)

(21) Appl. No.: 14/108,629

(22) Filed: Dec. 17, 2013

(30) Foreign Application Priority Data
Dec. 19, 2012 (JP) 2012-277464

(51) Int. Cl. G03G 15/01

(52) U.S. Cl. CPC G03G 15/0152
USPC 399/298; 399/299; 399/302

(57) ABSTRACT

An image forming apparatus comprises: an imaging unit including imaging subunits that are arranged in a vertical direction, each of the imaging subunits forming a toner image of a different color; an intermediate transfer belt having a running surface that runs vertically along the imaging subunits, and on which the toner images are primary-transferred and superposed; a secondary transfer unit secondary-transferring the toner images on the intermediate transfer belt to the recording sheet; and an ejection unit having an outlet and a conveyance path extending vertically, the ejection unit conveying, to the outlet via the conveyance path, the recording sheet on which the toner images have been secondary-transferred, wherein when viewed from a front of the image forming apparatus, the imaging unit is arranged behind the intermediate transfer belt, and the conveyance path is arranged in front of the intermediate transfer belt.

This application is based on an application No. 2012-277464 filed in Japan, the contents of which are hereby incorporated by reference.

### BACKGROUND OF THE INVENTION

(1) Field of the Invention

The present invention relates to an image forming apparatus for outputting color images, and in particular to an image forming apparatus having a reduced depth and high stability.

(2) Description of Related Art

In the field of image forming apparatuses for outputting color images (hereinafter “color image forming apparatus”), so-called tandem color image forming apparatuses have been mainstream in view of the enhancement of printing speed and image quality. In such a tandem color image forming apparatus, imaging units for forming toner images of respective developing colors, i.e., yellow, magenta, cyan, and black, are aligned along a belt suspended under tension in a substantially horizontal direction. The tandem color image forming apparatus forms a color image by superposing the toner images formed by the imaging units (see Japanese Patent Application Publication No. 2007-140144, for example).

In recent years, there is an increasing demand for a color image forming apparatus that is intended for the use in a store or the like, that includes a liquid crystal display or the like, and that outputs information displayed on the display onto a recording sheet in color and provides a customer in the store with the information printed in color on the recording sheet.

In the case of placing such a color image forming apparatus on the floor of a store or the like, it is desirable that the apparatus have a small depth and take as little space as possible so as not to obstruct a walkway and not to make the apparatus appear overwhelming to the customers.

However, in the conventional tandem color image forming apparatus as described above, the belt is arranged in the horizontal direction, and this has been a hindrance in reducing the footprint.

In view of the above, the color image forming apparatus may be formed as disclosed in Japanese Patent Application Publications No. 2001-109325 and No. 2006-276775. That is, the imaging units may be arranged in a vertical direction, and a color image may be formed on a recording sheet while the recording sheet is vertically conveyed by the belt. In this way, the depth of the color image forming apparatus itself can be reduced.

However, according to such a structure disclosed in Japanese Patent Application Publications No. 2001-109325 and No. 2006-276775, toner images formed by the imaging units are sequentially and directly transferred onto a recording sheet while the recording sheet is vertically conveyed by the belt (this structure is hereinafter referred to as “direct transfer method”).

In a color image forming apparatus employing the direct transfer method, a conveyance malfunction (i.e., paper jam) of a recording sheet often occurs between the belt and the imaging units, and a process for correcting such a conveyance malfunction (i.e., jam processing) is necessary. Accordingly, Japanese Patent Application Publication No. 2006-276775 discloses the following structure, for example. That is, a front door is provided that can be freely opened and closed, and a transfer belt unit, which includes a belt, a supporting frame, primary transfer rollers, and a drive source, are mounted on an inner side of the front door. When the front door is opened, the transfer belt unit moves forward, and separates from the imaging units.

The above structure simplifies jam processing in a vertical color image forming apparatus. However, for the purpose of the accuracy of image formation, it is necessary that the supporting frame, roller shafts, and the like in the transfer belt unit be made of metal for greater rigidity. Also, it is necessary that the drive source in the transfer belt unit be made with a motor having a relatively high torque to ensure the stable rotation of the belt. As a result, the total weight of the transfer belt unit becomes quite large, and can be 5 kg depending on the model.

Accordingly, if the front door used for maintenance is opened to a predetermined angle, the transfer belt unit also moves forward as if to fall over. As a result, the center of gravity of the color image forming apparatus moves forward, causing the color image forming apparatus to be susceptible to falling forward.

### SUMMARY OF THE INVENTION

The present invention has been achieved in view of the above problem, and an aim thereof is to provide a vertical color image forming apparatus in which a plurality of imaging units are arranged in a vertical direction so as to reduce the depth of the color image forming apparatus itself, and that can be stably installed and is unlikely to fall over during the maintenance such as jam processing.

In order to achieve the above aim, an aspect of the present invention provides an image forming apparatus for forming a color image on a recording sheet by superposing a plurality of toner images, the image forming apparatus comprising: an imaging unit including a plurality of imaging subunits that are arranged in a vertical direction, each of the imaging subunits being configured to form a toner image of a different color; an intermediate transfer belt having a running surface that runs vertically along the imaging subunits, and on which the toner images formed by the imaging subunits are primary-transferred and superposed; a secondary transfer unit configured to secondary-transfer the toner images on the intermediate transfer belt to the recording sheet; and an ejection unit having an outlet and a conveyance path extending vertically, the ejection unit being configured to convey, to the outlet via the conveyance path, the recording sheet on which the toner images have been secondary-transferred, wherein when viewed from a front of the image forming apparatus, the imaging unit is arranged behind the intermediate transfer belt, and the conveyance path is arranged in front of the intermediate transfer belt.

### BRIEF DESCRIPTION OF THE DRAWINGS

These and the other objects, advantages and features of the invention will become apparent from the following description thereof taken in conjunction with the accompanying drawings that illustrate a specific embodiment of the invention.

In the drawings:

FIG. 1 is an external perspective view of a color image forming apparatus according to an embodiment of the present invention;

FIG. 2 is a schematic cross-sectional view showing the inner structure of the color image forming apparatus at the left side, when the color image forming apparatus is viewed from the front;

FIG. 3 is a magnified view showing a main part of an image forming unit of the color image forming apparatus;

FIGS. 4A and 4B each show the shift of the center of gravity of the color image forming apparatus caused by opening and closing of a front door of the color image forming apparatus according to the embodiment;

FIG. 5A schematically shows the structure of a conventional horizontal color printer as a comparative example, and FIG. 5B shows the position of the center of gravity of this color printer in the comparative example;

FIG. 6A schematically shows the structure of a conventional vertical color printer as another comparative example, and FIGS. 6B and 6C each show the shift of the center of gravity of this color printer in the comparative example caused by opening and closing of a front door of the color printer;

FIGS. 7A and 7B each show a state where metal fittings for fall prevention are attached to the vertical color printer in the comparative example shown in FIGS. 6A to 6C;

FIG. 8 is a schematic cross-sectional view showing the structure of a color image forming apparatus according to a modification of the present invention; and

FIG. 9 is a partial magnified view showing a main part of an imaging subunit of the color image forming apparatus shown in FIG. 8.

### DESCRIPTION OF PREFERRED EMBODIMENTS

The following describes an embodiment of an image forming apparatus according to the present invention, with use of an example of a color image forming apparatus including a large liquid crystal display device.

(1) Structure of Color Image Forming Apparatus

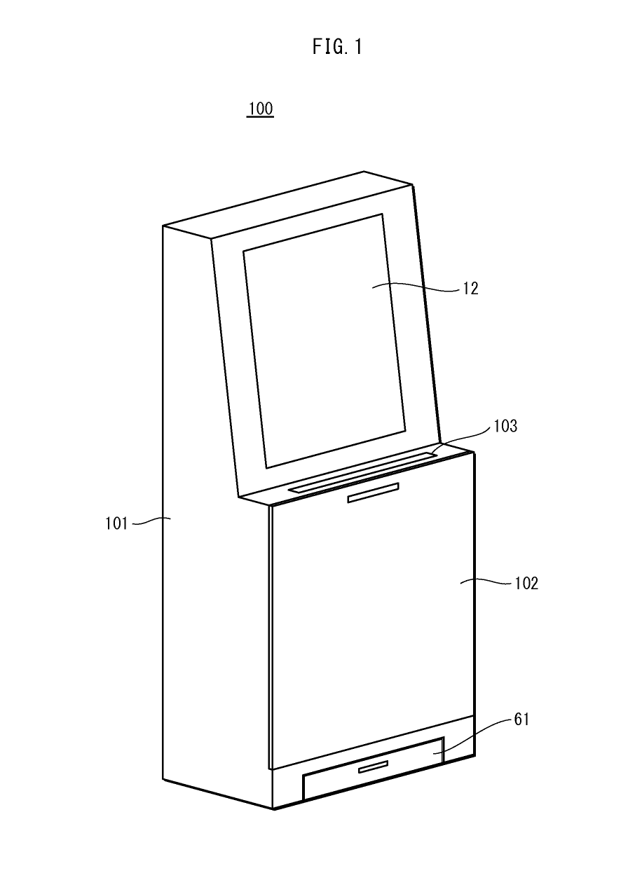

FIG. 1 is an external perspective view of a color image forming apparatus 100 according to the present embodiment.

As shown in FIG. 1, the color image forming apparatus 100 includes a large crystal liquid display device 12 (hereinafter simply “display device 12”) having a touch panel. The display device 12 is provided at an upper part of an apparatus body 101 of the color image forming apparatus 100. The display device 12 functions as an input/output unit of an information terminal.

The color image forming apparatus 100 is approximately 1710 mm in height, 700 mm in width (length at the front in a crosswise direction), and 400 mm in depth.

The display device 12 has a screen with a size of approximately 40 inches, and is provided at a height that allows a user of an average height to easily operate the screen when the user stands in front of the color image forming apparatus 100. Furthermore, the display device 12 is inclined backwards at an appropriate angle (e.g., 10 degrees) so that the user can easily look at the entire screen.

Note that the above measurements are merely an example of the present embodiment, and no limitation is intended thereby.

The color image forming apparatus 100 is provided with a sheet outlet 103 at a front side thereof. Specifically, the sheet outlet 103 is positioned in substantially the center of the apparatus body 101 and under the display device 12. After an image forming unit 2 of the color image forming apparatus 100 prints an image on a recording sheet, the recording sheet is ejected from the sheet outlet 103. The sheet outlet 103 faces upwards in a vertical direction, so that the user standing in front of the display device 12 can easily check the ejection of a recording sheet on which an intended image has been printed, and does not forget to pick up the recording sheet.

If the image forming apparatus 100 was configured to eject the recording sheet forward (i.e., toward the user) in a horizontal direction, then it would be necessary to provide an ejection tray protruding forward. However, as described above, the image forming apparatus 100 is configured to eject the recording sheet upwards from the sheet outlet 103, which is advantageous in terms of reducing the depth of the color image forming apparatus 100.

In addition, this structure makes it possible to set a sheet ejecting position to be relatively high. This is convenient for the user since the user does not need to bend down to pick up a recording sheet.

The user or a serviceman can pull open a front door 102 used for maintenance and perform a maintenance work such as jam processing or replacement of a consumable article.

The front door may be opened in a crosswise direction about a pivot provided at either a left or right side of the apparatus body 101.

Resupply of recording sheets can be performed by pulling out a paper feed cassette 61.

The color image forming apparatus 100 is expected to be installed in a public place. Accordingly, it is desirable that the front door 102 or the paper feed cassette 61 be locked so that people passing by cannot touch the internal components or take out the recording sheets without permission.

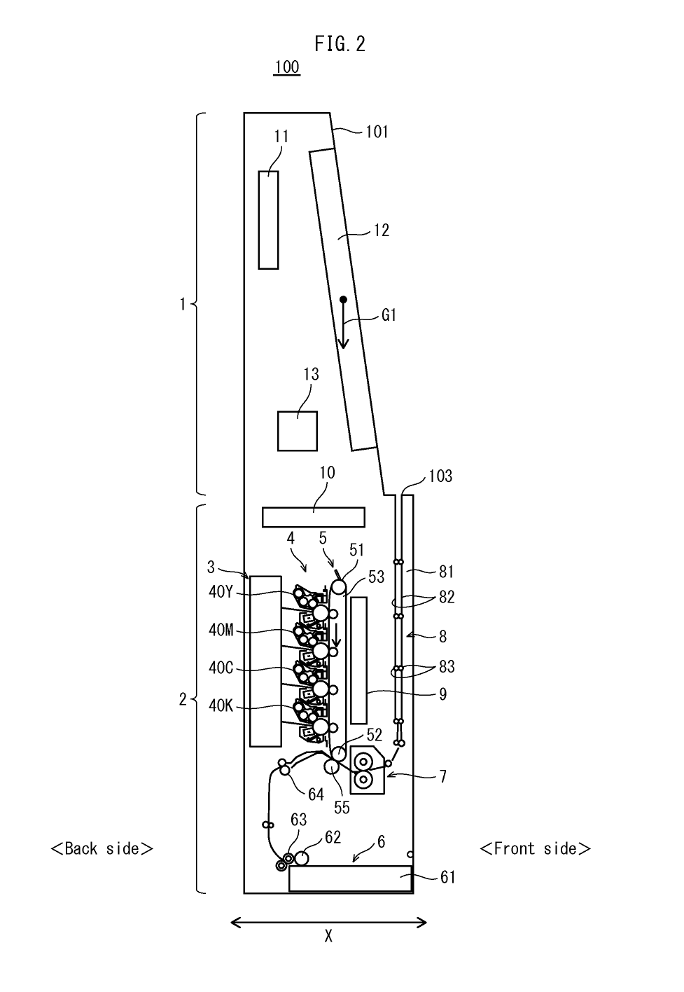

FIG. 2 is a schematic cross-sectional view when the color image forming apparatus 100 in FIG. 1 is seen from the left side, and illustrates the inner structure of the color image forming apparatus 100.

As shown in FIG. 2, the color image forming apparatus 100 includes: an information processing unit 1 provided in an upper part of the apparatus body 101; and the image forming unit 2 provided in a lower part of the apparatus body 101.

The information processing unit 1 includes a personal computer (PC) unit 11, the display unit 12, and a speaker unit 13. The PC unit 11 mainly includes a CPU, a storage device, and a wireless LAN device for wirelessly connecting to the Internet. The display unit 12 is, as described above, a large liquid crystal display device with a touch panel which functions as an input/output unit of the PC unit 11. The speaker unit 13 provides the user with audio guidance on operation procedures, plays a BGM during operations, and so on.

The user stands in front of the color image forming apparatus 100, and performs an input operation by touching the screen of the display device 12. The display device 12 is arranged such that the center of gravity G1 of the display device 12 is more forward than the center of the color image forming apparatus 100 in a depth direction. In this way, the weight balance of the apparatus in the depth direction (in particular, the weight balance between the display device 12 and the image forming unit 2) becomes more stable.

The PC unit 11 receives an input of the user via the display device 12, and performs an operation according to the input. For example, the PC unit 11 accesses the internal storage device or either an external server or a dedicated website via the wireless LAN device, acquires content requested by the user, and causes the display device 12 to display the content. Also, the PC unit 11 causes the speaker unit 13 to provide the user with necessary audio guidance, a store guide, and a comfortable BGM.

If the user wishes to print out the content displayed on the display device 12, the user performs a touch input to give a print instruction.

The PC unit 11 receives the print instruction, transmits image data of the content to the image forming unit 2, and instructs the image forming unit 2 to print out the content onto a recording sheet.

The image forming unit 2 is composed of a vertical tandem color printer. Upon receiving the print instruction from the information processing unit 1, the image forming unit 2 forms toner images of yellow, magenta, cyan, and black, and superposes these toner images to form a full-color image.

Hereinafter, the reproduction colors of yellow, magenta, cyan, and black are respectively denoted by Y, M, C, and K. The components pertaining to the reproduction colors are indicated by reference signs with Y, M, C, and K.

The image forming unit 2 includes an exposure-scanning unit 3, an imaging unit 4, an intermediate transfer belt unit 5, a paper feeding unit 6, a fixing unit 7, a sheet conveyance unit 8, and a control unit 9.

The rotation axes of photosensitive drums in the imaging unit 4 and the rotation axes of rotatable bodies, such as rollers, are all arranged parallel to a width direction of the apparatus body 101 of the color image forming apparatus 100. This allows a recording sheet to be ejected from the sheet outlet 103 in an orientation parallel to a front surface of the apparatus body 101.

The imaging unit 4 is arranged more backward in the color image forming apparatus 100 (closer to a back surface of the apparatus body 101) than the intermediate transfer belt unit 5. The imaging unit 4 includes imaging subunits 40Y, 40M, 40C, and 40K which are vertically aligned in the stated order along a running surface of the intermediate transfer belt 53.

The exposure-scanning unit 3 is arranged more backward than the imaging unit 4. The exposure-scanning unit 3 includes four laser diodes, and optical elements such as polygon mirrors and scanning lenses. The optical elements cause laser beams emitted from the laser diodes to scan in a main scanning direction. The exposure-scanning unit 3 modulates the laser beams of the respective colors Y to K according to drive signals from the control unit 9, and exposure-scans the photosensitive drums of the imaging subunits 40Y, 40M, 40C, and 40K to form electrostatic latent images.

The intermediate transfer belt unit 5 is arranged in a middle portion of the color image forming apparatus 100 in the depth direction thereof. The intermediate transfer belt unit 5 includes: a drive roller 52 and a driven roller 51 that are arranged one above the other in the vertical direction; an endless intermediate transfer belt 53 that is wound around the drive roller 52 and the driven roller 51 and suspended under tension such that the running surface of the intermediate transfer belt 53 in a vertical direction thereof is substantially included in a vertical plane; and a drive source which is not illustrated. The drive source causes the intermediate transfer belt 53 to rotate in the direction indicated by the arrow in FIG. 2.

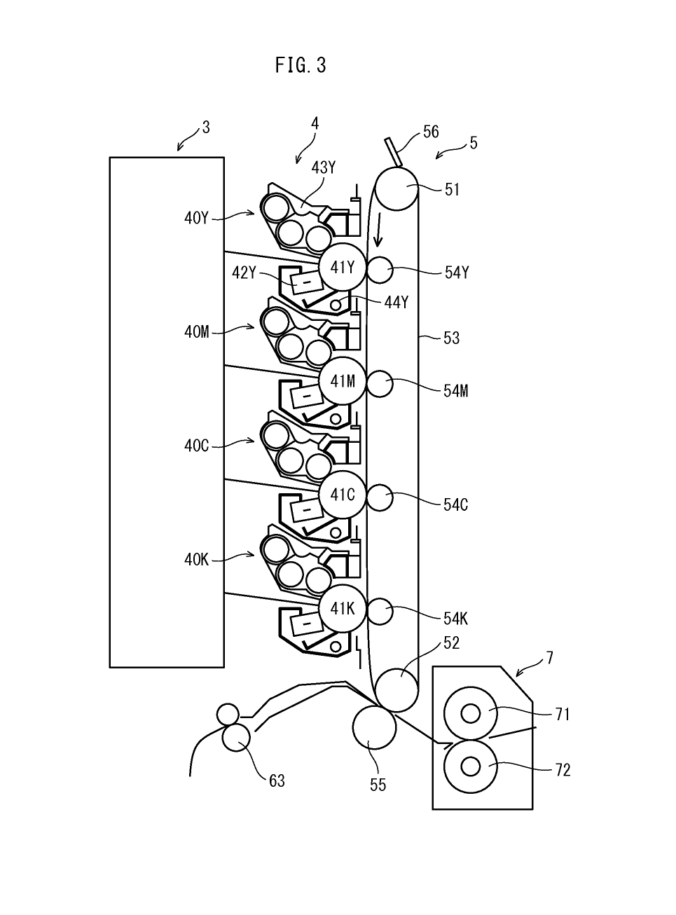

FIG. 3 is a magnified view showing a main part of the image forming unit 2 in FIG. 2.

The imaging subunit 40Y is arranged at a top tier in the imaging unit 4. The imaging subunit 40Y includes a photosensitive drum 41Y, a charger 42Y, a developer 43Y, and a cleaner 44Y for cleaning a surface of the photosensitive drum 41Y. The charger 42Y, the developer 43Y, and the cleaner 44Y are provided around the photosensitive drum 41Y.

A photosensitive surface (circumferential surface) of the photosensitive drum 41Y is uniformly charged by the charger 42Y, and is scanned by a laser beam emitted by the exposure-scanning unit for image formation with the color yellow. As a result, an electrostatic latent image is formed on the circumferential surface of the photosensitive drum 41Y.

This electrostatic latent image is developed with a supply of yellow toner from the developer 43Y, and a yellow toner image is formed on the circumferential surface of the photosensitive drum 41Y.

The yellow toner image formed on the circumferential surface of the photosensitive drum 41Y is transferred onto the intermediate transfer belt 53 by an electrostatic force. This electrostatic force is generated as a result of primary transfer voltage applied to a primary transfer roller 54Y which is arranged inside the intermediate transfer belt 53. After the yellow toner image is transferred, the cleaner 44Y removes residual toner on the circumferential surface of the photosensitive drum 41Y.

The imaging subunits 40M, 40C, and 40K have a similar structure as the imaging subunit 40Y. That is, the imaging subunits 40M, 40C, and 40K form toner images of developing colors corresponding to photosensitive drums 41M, 41C, and 41K, and the toner images thus formed are superposed onto the intermediate transfer belt 53 by primary transfer rollers 54M, 54C, and 54K.

The imaging subunits 40Y, 40M, 40C, and 40K form toner images at different timings that are each shifted by a predetermined time period, so that the toner images of the respective developing colors are superposed at the same position on the intermediate transfer belt 53.

Returning to FIG. 2, the paper feeding unit 6 includes the paper feed cassette 61, a pickup roller 62, a pair of separation rollers 63, and a pair of timing rollers 64. The paper feed cassette 61 contains recording sheets. The pickup roller 62 picks up the recording sheets in the paper feed cassette 61. The pair of separation rollers 63 prevents multiple feed of the recording sheets picked up by the pickup roller 62. The pair of timing rollers 64 adjusts the timing to convey the recording sheet to a secondary transfer position (a position at which the intermediate transfer belt 53 makes contact with a secondary transfer roller 55).

The paper feed cassette 61 has a conventional structure. For example, a spring or the like, which is not illustrated, may push a bottom plate of the paper feed cassette 61 upwards, so that the uppermost recording sheet among the bundle of recording sheets loaded in the paper feed cassette 41 is constantly in contact with the pickup roller 62. Alternatively, it is possible to provide a sensor that detects the uppermost recording sheet among the bundle of recording sheets. Then, based on the detection result, a cam or the like may be driven to cause the bottom plate of the paper feed cassette 61 to move up and down, so that the uppermost recording sheet among the bundle of recording sheets makes contact with the pickup roller 62.

The pair of timing rollers 64 conveys the recording sheet to the secondary transfer position at the timing when the color toner images, which have been primary-transferred on the intermediate transfer belt 53, are transferred to the secondary transfer position. At the secondary transfer position, the color toner images on the intermediate transfer belt 53 are collectively secondary-transferred onto the recording sheet by an electrostatic force resulting from secondary transfer voltage applied to the secondary transfer roller 55.

As shown in FIG. 3, a cleaning blade 56 is arranged to oppose the driven roller 51 with the intermediate transfer belt 53 therebetween. This structure allows removal of the residual toner on the intermediate transfer belt 53. The removed residual toner is collected into a waste toner box which is not illustrated.

The recording sheet on which the color toner images have been secondary-transferred by the secondary transfer roller 55 is further conveyed to the fixing unit 7. At the fixing unit 7, the recording sheet passes through a fixing nip formed between a heating roller 71 and a pressuring roller 72, whereby the color toner images (unfixed images) on the recording sheet are thermally fixed.

As shown in FIG. 2, the recording sheet that has been thermally fixed by the fixing unit 7 is conveyed upwards to the sheet outlet 103 via an ejection conveyance path 81 in a sheet ejection unit 8.

The ejection conveyance path 81 is formed from at least one pair of guide plates 82. Along the ejection conveyance path 81, pairs of ejection rollers 83 are provided so as to convey the recording sheet in the ejection conveyance path 81 toward the sheet outlet 103.

Of each pair of ejection rollers 83, an ejection roller closer to the intermediate transfer belt unit 5, for example, is configured to be driven by a single driving source via a timing belt which is not illustrated.

As shown in FIG. 2, the ejection conveyance path 81 is immediately adjacent to an inner side of the front door 102, and extends vertically along the front door 102. Accordingly, jam processing can be easily performed by opening the front door 102 and pulling out a jammed recording sheet from a gap between the pair of guide plates 82.

It is possible to further facilitate jam processing by forming the guide plates 82 as follows. That is, out of the pair of guide plates forming the ejection conveyance path 81, the guide plate closer to the front door 102 may be attached to the inner side of the front door 102, and the guide plates may separate from each other when the front door 102 is open. The guide plates 82 are much lighter than the intermediate transfer belt unit 5. Therefore, forming the guide plates as described above does not cause the center of gravity of the color image forming apparatus 100 to move forward largely and make the color image forming apparatus 100 unstable when the front door 102 is open.

The control unit 9 includes a CPU, a ROM, and a RAM. The CPU reads a necessary program from the ROM and, while using the RAM as a work area, comprehensively controls operations of the exposure-scanning unit 3, the imaging unit 4, the intermediate transfer belt unit 5, the paper feeding unit 6, the fixing unit 7, the sheet conveyance unit 8, etc., and thereby smoothly performs the print operation described above.

In a position above the imaging unit 4 and substantially in the middle of the color image forming apparatus 100 in the vertical direction, a low-voltage power supply substrate 10 is provided to supply power to the control unit 9 and the PC unit 11. Also, when viewed from the front of the color image forming apparatus 100, a high-voltage power supply (not illustrated) is provided further toward the right side (i.e., backward in a direction perpendicular to FIG. 2) than the imaging unit 4 and the intermediate transfer belt unit 5. The high-voltage power supply applies high voltage to the transfer rollers, the charger, and a developing roller.

(2) The present embodiment employs the structure as described above, which achieves a thinner color image forming apparatus including a large display device. This structure allows the color image forming apparatus to be stably installed, and effectively prevents the color image forming apparatus from falling over when the front door is opened for jam processing or a maintenance work.

The following describes such advantageous effects produced by the above structure, in comparison to a color image forming apparatus including a conventional tandem color printer.

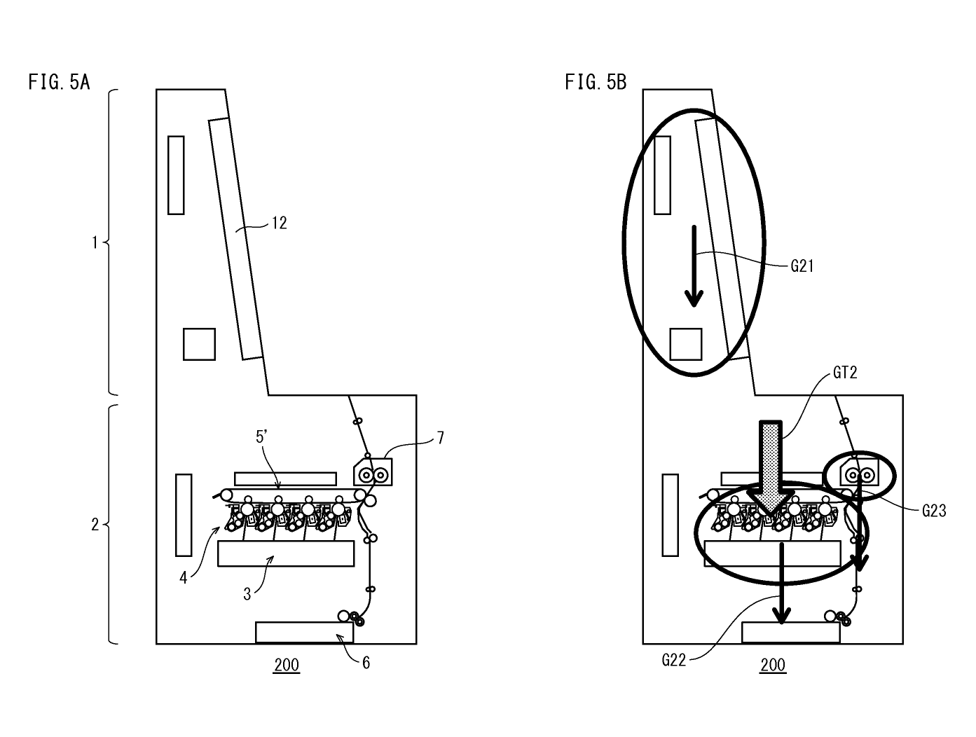

FIG. 5A is a schematic cross-sectional view showing a color image forming apparatus 200 including a tandem color printer. In this tandem color printer, a transfer belt is suspended under tension in a horizontal direction, and imaging subunits are horizontally aligned along a running surface of the transfer belt.

In this structure, as shown in FIG. 5B, gravity GT2 acting on the center of gravity of the color image forming apparatus 200 as a whole, which is the total sum of: gravity G21 acting on the center of gravity of the information processing unit 1; gravity G22 acting on the center of gravity of the image forming unit 2 (excluding the fixing unit 7); and gravity G23 acting on the center of gravity of the fixing unit 7, is positioned more backward than the center of the color image forming apparatus 200 in a depth direction. Accordingly, the color image forming apparatus 200 is highly stable and unlikely to fall over. However, the depth of the color image forming apparatus 200 is large, and this clearly does not contribute to space saving and leads to a limitation of possible installation locations. Furthermore, since a user operates the color image forming apparatus 200 while standing, the display device needs to be arranged at a relatively high position without a change in the size of the installation space. This makes the color image forming apparatus 200 appear overwhelming to the customers, etc.

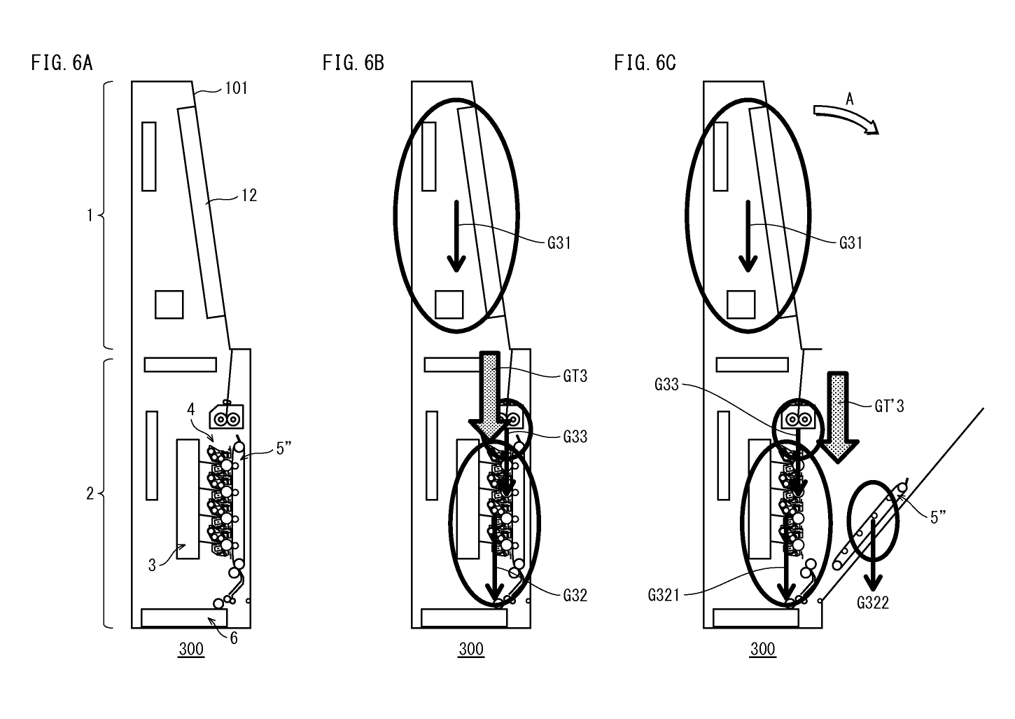

FIG. 6A shows a color image forming apparatus 300, which includes a tandem color printer using a direct transfer method disclosed in Japanese Patent Application Publications No. 2001-109325 and No. 2006-276775. This tandem color printer is described above in the section of “BACKGROUND OF THE INVENTION”. In the tandem color printer, the imaging subunits in the imaging unit 4 and other components are arranged in a vertical direction to reduce the depth of the color image forming apparatus 300. However, since this tandem color printer employs the direct transfer method, a paper jam occurs between the imaging unit 4 and a transfer belt unit 5″. Accordingly, it is necessary to arrange the transfer belt unit 5″ at the inner side of the front door 102 to facilitate jam processing. This leaves no choice but to arrange the image formation unit closer to the front side of the color image forming apparatus 300.

Since the display device 12, which is large and heavy, is arranged in the upper part of the color image forming apparatus 300, the center of gravity of the color image forming apparatus 300 is located slightly upwards. However, the total weight of the transfer belt unit 5″ is relatively large, and, since this transfer belt unit 5″ is located closer to the front side of the color image forming apparatus 300, gravity GT3 acting on the center of gravity of the color image forming apparatus 300 also moves forward (see FIG. 6B), causing the color image forming apparatus 300 to be susceptible to falling forward.

Furthermore, when the front door 102 is pulled open for jam processing or a maintenance work, the position of gravity G322 acting on the center of gravity of the transfer belt unit 5″ moves forward separately from gravity G321 acting on the center of gravity of the imaging unit 4, as shown in FIG. 6C. As a result, gravity GT′3 acting on the center of gravity of the color image forming apparatus 300 may move more forward than a front edge of a bottom surface of the apparatus body 101, which increases the possibility of the color image forming apparatus 300 falling over.

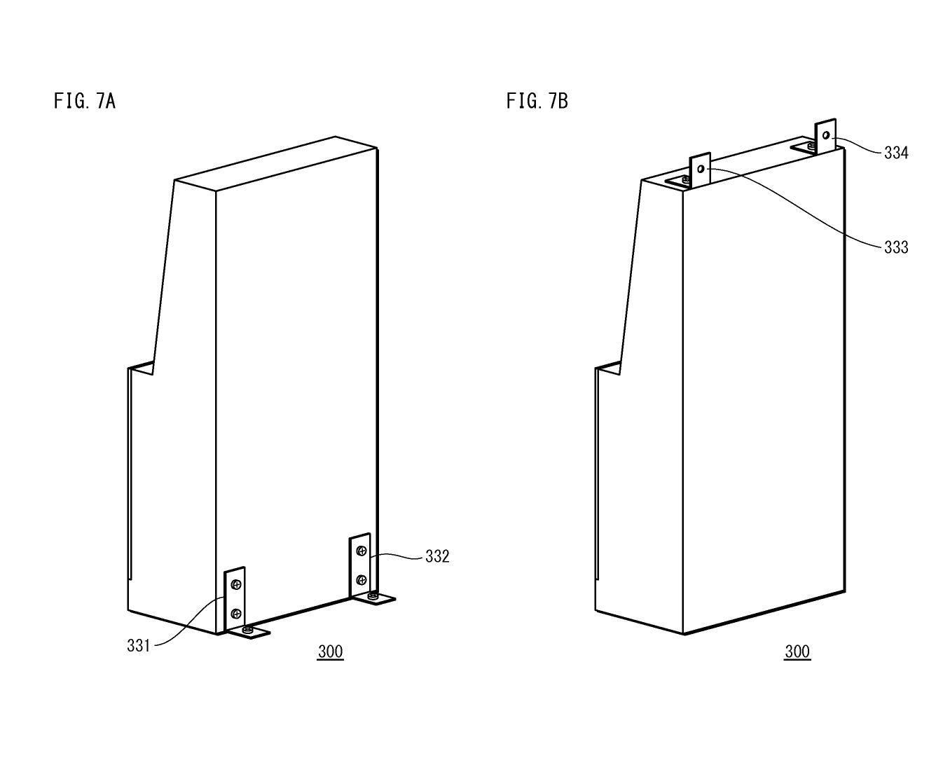

To prevent such a fall, as shown in FIG. 7A, it is necessary that metal fittings 331 and 332 for fall prevention be provided at a bottom of a back surface of the color image forming apparatus 300, and that the color image forming apparatus 300 be bolted to the floor via the metal fittings 331 and 332. Alternatively, as shown in FIG. 7B, it is necessary that metal fittings 333 and 334 for fall prevention be provided at a top of the back surface of the color image forming apparatus 300, and that the color image forming apparatus 300 be bolted to the wall via the metal fittings 333 and 334. This necessitates drilling screw holes in the floor or in the wall, and makes the installation work costly and time-consuming. In addition, possible installation locations will be limited. Furthermore, the above structure is inconvenient, since the color image forming apparatus 300 having the above structure cannot be easily moved according to a change in the layout of a store, etc.

On the other hand, the color image forming apparatus 100 according to the present embodiment has the structure as shown in FIG. 2. Specifically, the intermediate transfer belt unit 5, which is relatively heavy, is arranged in the middle portion of the color image forming apparatus 100 in the depth direction (X direction) thereof, and the imaging unit 4 and the exposure-scanning unit 3 are arranged more backward (closer to the back surface of the color image forming apparatus 100) than the intermediate transfer belt unit 5. Also, since the control unit 9 and the ejection conveyance path 81 of the sheet conveyance unit 8 are arranged more forward (closer to the front surface of the color image forming apparatus 100) than the intermediate transfer belt unit 5, the weight balance in the depth direction of the color image forming apparatus 100 is improved and the stability of the color image forming apparatus 100 is increased.

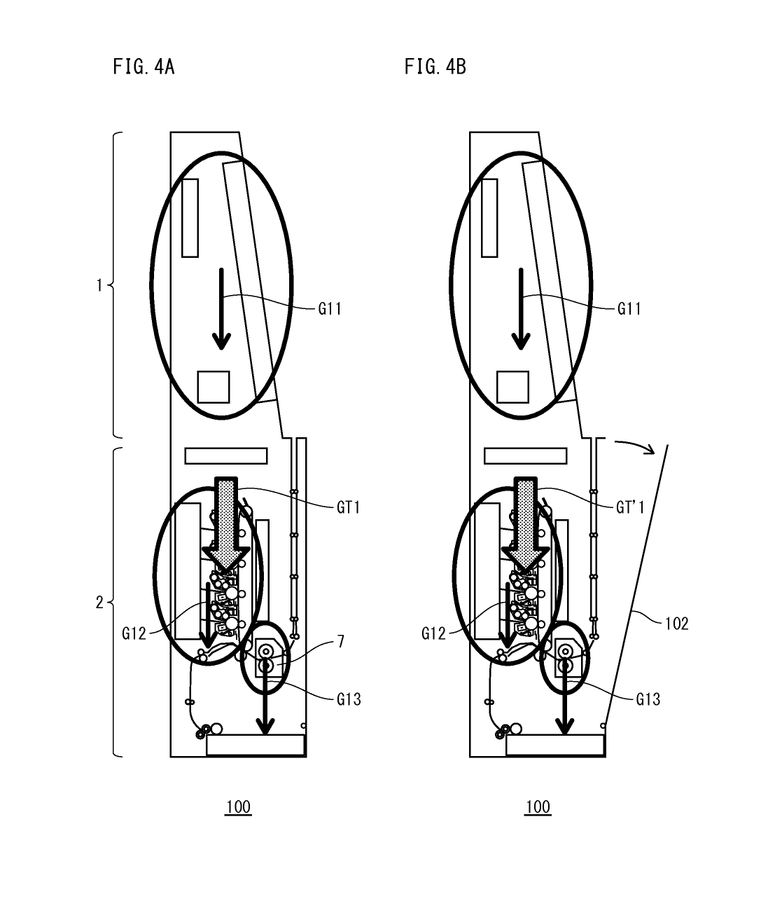

In other words, as shown in FIG. 4A, gravity G12 acting on the center of gravity of the image forming unit 2 (excluding the fixing unit 7) in the color image forming apparatus 100 is located more backward than the center of the color image forming apparatus 100. Also, gravity GT1 acting on the center of gravity of the color image forming apparatus 100 as a whole, which is the total sum of: the gravity G12 acting on the center of gravity of the image forming unit 2 (excluding the fixing unit 7); gravity G11 acting on the center of gravity of the information processing unit 1; and gravity G13 acting on the center of gravity of the fixing unit 7, is positioned slightly more backward than the center of the color image forming apparatus 100 in the depth direction. Furthermore, as shown in FIG. 4B, even when the front door 102 is opened for a maintenance work or the like, the intermediate transfer belt unit 5 does not move along with the front door 102. Accordingly, the position of gravity GT′1 acting on the center of gravity of the color image forming apparatus 100 when the front door 102 is open does not change much from the position of the gravity GT1 before the front door 102 is opened. This allows the color image forming apparatus 100 to be stably installed.

Also, the paper feeding unit 6, and the fixing unit 7, which is relatively heavy, are arranged under the intermediate transfer belt unit 5. By arranging the fixing unit 7 in a lower part of the color image forming apparatus 100, the center of gravity of the apparatus can be lowered, as compared to a structure as shown in FIG. 6A in which the fixing unit is located above the transfer belt unit 5″. Furthermore, the stability of the color image forming apparatus 100 can be increased.

Such a structure eliminates the need for the metal fittings for fall prevention as shown in FIGS. 7A and 7B, and increases the number of possible installation locations.

Note that as long as a stable weight balance as described above can be achieved, the intermediate transfer belt unit 5 does not need to be located exactly in the middle of the apparatus body 101 in the depth direction, in other words, a small deviation is acceptable in positioning the intermediate transfer belt unit 5.

As described above, according to the present invention, the imaging unit includes the imaging subunits that are arranged in the vertical direction, and the intermediate transfer belt is arranged such that the running surface thereof runs vertically along the imaging subunits. This structure allows for reduction in the depth of the image forming apparatus. Furthermore, the toner images of the respective developing colors are superposed (primary-transferred) onto the intermediate transfer belt, and these color toner images are collectively secondary-transferred onto the recording sheet. Subsequently, the recording sheet on which the color toner images have been secondary-transferred is ejected via the conveyance path. This structure eliminates the need for directly transferring the toner images onto the recording sheet while the recording sheet is conveyed by the intermediate transfer belt, unlike a conventional image forming apparatus employing the direct transfer method. As a result, a conveyance malfunction (paper jam) of the recording sheet is unlikely to occur between the intermediate transfer belt and the imaging subunits. Accordingly, the transfer belt unit, which includes the intermediate transfer belt, the supporting frame thereof, and the drive source for driving the intermediate transfer belt and is thus relatively heavy, does not need to be arranged closer to the front side of the image forming apparatus for the purpose of jam processing or the like. Furthermore, according to the above structure, when viewed from the front of the image forming apparatus, the imaging unit is arranged behind the intermediate transfer belt, and the conveyance path of the ejection unit is arranged in front of the intermediate transfer belt. This makes it possible to move the center of gravity of the image forming apparatus in the depth direction thereof closer to the back side of the image forming apparatus. In addition, since the conveyance path through which the recording sheet is conveyed is located closer to the front side of the image forming apparatus, a maintenance work such as jam processing can be easily performed.

<Modifications>

Although the color image forming apparatus according to the present invention has been described above with reference to the embodiment, the present invention is not limited to the embodiment. The following modifications are also possible.

(1) According to the above embodiment, the components including optical elements, such as polygon mirrors, are used as the exposure-scanning unit 3, for example. Such a structure, however, causes the size of the exposure-scanning unit 3 to be relatively large.

Accordingly, in the present modification, a well-known LED array is used as the exposure-scanning unit 3. Specifically, the LED array is formed by arranging small LEDs (light-emitting diodes) in rows or in a zigzag pattern in a main-scanning direction at a pitch of one pixel.

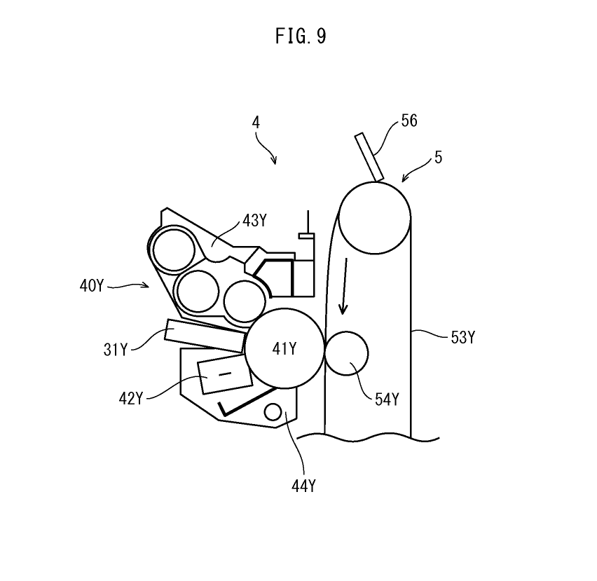

FIG. 9 shows the structure of the imaging subunit 40Y in the present modification.

As shown in FIG. 9, an LED array 31Y is compact in size, and is arranged in the vicinity of the circumferential surface of the photosensitive drum 41Y. An LED array is formed similarly for each of the imaging subunits 40M, 40C, and 40K. This makes it possible to free the space occupied by the exposure-scanning unit 3 in the above embodiment, which is located behind the imaging unit 4 in the depth direction of the color image forming apparatus 100.

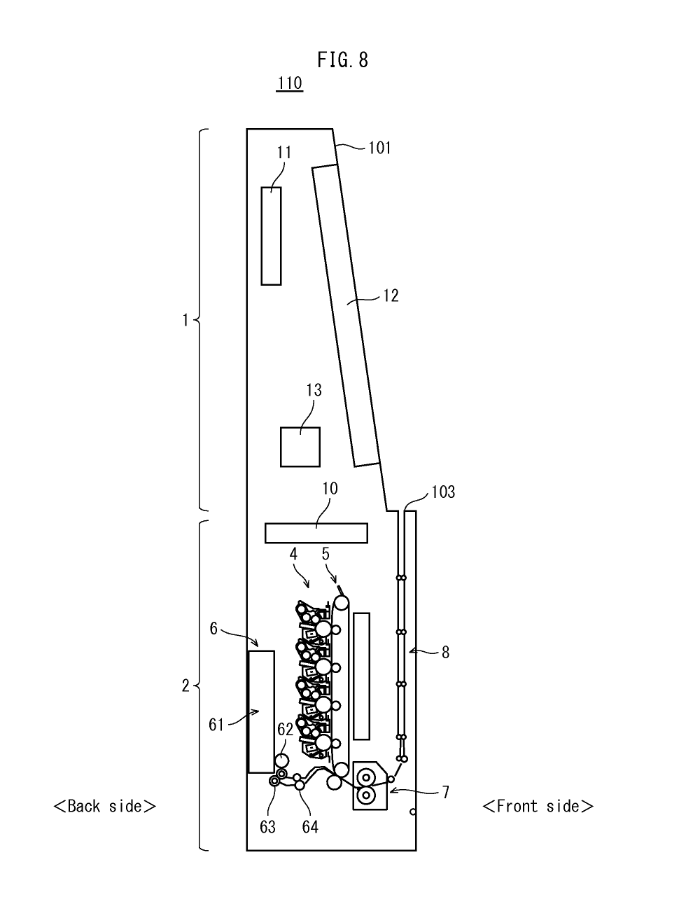

Accordingly, for example, the paper feed cassette 61 may be arranged in a vertical direction in this free space behind the imaging unit 4, as shown in FIG. 8. Forming the exposure-scanning unit 3 with the LED arrays allows greater flexibility in the layout of the internal components, and the weight balance among the internal components in the depth direction of the color image forming apparatus 100 can be further improved. Furthermore, since the paper feed cassette 61 is no longer arranged at the lower part of the color image forming apparatus 100, the height of the apparatus can be decreased by the amount equivalent to the space taken by the paper feed cassette 61. This makes it possible, for example, to provide a color image forming apparatus having a height appropriate for use by children and women.

(2) According to the above embodiment, the color image forming apparatus includes the information processing unit 1 having the large display device, which is arranged in the upper part of the color image forming apparatus. However, the information processing unit 1 is not absolutely necessary for the color image forming apparatus. For example, the information processing unit 1 may be removed, and only the image forming unit 2 in the lower part of the color image forming apparatus may be used as an independent vertical printer or, alternatively, may be used as an image forming unit for a copier, a facsimile device, or the like. Such a color image forming apparatus has improved usability and can be installed in various offices and houses, since it does not take much space and is unlikely to fall over.

The embodiment and the modifications described above may be combined appropriately.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. An image forming apparatus for forming a color image on a recording sheet by superposing a plurality of toner images, the image forming apparatus comprising:
an imaging unit including a plurality of imaging subunits that are arranged in a vertical direction, each of the imaging subunits being configured to form a toner image of a different color;
an intermediate transfer belt having a running surface that runs vertically along the imaging subunits, and on which the toner images formed by the imaging subunits are primary-transferred and superposed;
a secondary transfer unit configured to secondary-transfer the toner images on the intermediate transfer belt to the recording sheet; and
an ejection unit having an outlet and a conveyance path extending vertically, the ejection unit being configured to convey, to the outlet via the conveyance path, the recording sheet on which the toner images have been secondary-transferred, wherein
when viewed from a front of the image forming apparatus, the imaging unit is arranged behind the intermediate transfer belt, and the conveyance path is arranged in front of the intermediate transfer belt.

2. The image forming apparatus of claim 1, wherein
the intermediate transfer belt is arranged in a middle portion of the image forming apparatus in a depth direction thereof.

3. The image forming apparatus of claim 1, further comprising
a display device having a display screen, and arranged in an upper portion of the image forming apparatus such that the display screen faces an operator.

4. The image forming apparatus of claim 3, wherein
the display device is arranged such that a center of gravity of the display device is positioned more forward than a center of the image forming apparatus in a depth direction thereof.

5. The image forming apparatus of claim 1, further comprising
a fixing unit arranged in a lower portion of the image forming apparatus, and configured to fix the toner images that have been secondary-transferred on the recording sheet.

6. The image forming apparatus of claim 1, wherein
each of the imaging subunits in the imaging unit includes a photosensitive rotational body, and
the image forming apparatus further comprises an exposure unit configured to expose a circumferential surface of each photosensitive rotational body, the exposure unit being arranged more backward than the imaging unit in a depth direction of the image forming apparatus.

7. The image forming apparatus of claim 1, wherein
each of the imaging subunits in the imaging unit includes a photosensitive rotational body, and
the image forming apparatus further comprises:
an exposure unit that is formed from an LED array and configured to expose a circumferential surface of each photosensitive rotational body; and
a sheet feeder having a paper feed cassette and configured to convey the recording sheet from the paper feed cassette to a position at which the secondary transfer unit secondary-transfers the toner images, the paper feed cassette being arranged vertically and more backward than the imaging unit in a depth direction of the image forming apparatus.
